(19) United States
(12) Patent Application Publication
(10) Pub. No.: US 2023/0281998 A1
(43) Pub. Date: Sep. 7, 2023

(54) TRACK RESTORATION METHOD, TRACK RESTORATION DEVICE AND NON-TRANSITORY COMPUTER-READABLE STORAGE MEDIUM

(71) Applicant: Baidu Online Network Technology (Beijing) Co., Ltd., Beijing (CN)

(72) Inventors: Yanyan LI, Beijing (CN); Yang Yang, Beijing (CN); Haoyang DING, Beijing (CN); He GAO, Beijing (CN); Dejing DOU, Beijing (CN)

(73) Assignee: Baidu Online Network Technology (Beijing) Co., Ltd., Beijing (CN)

(21) Appl. No.: 18/171,269

(22) Filed: Feb. 17, 2023

(30) Foreign Application Priority Data
May 12, 2022 (CN) 202210517361.8

(51) Int. Cl. G06V 20/54; G01C 21/00

(52) U.S. Cl. CPC G06V 20/54; G01C 21/3841

(57) ABSTRACT

A track restoration method, a track restoration device and a non-transitory computer-readable storage medium are provided, related to the field of intelligent transportation. The track restoration method includes: acquiring vehicle-passing data in a target area, where the vehicle-passing data is generated based on shooting data, and the shooting data is obtained by shooting a vehicle in the target area by a shooting device in the target area; restoring a driving track of the vehicle shot by the shooting device, based on the vehicle-passing data.

### CROSS REFERENCE OF RELATED APPLICATION

The present application claims a priority of Chinese patent application No. 202210517361.8 filed on May 12, 2022, which is incorporated herein by reference in its entirety.

### TECHNICAL FIELD

The disclosure relates to the technical field of data processing, in particular to the field of intelligent transportation, in particular to a track restoration method, a track restoration device and a non-transitory computer-readable storage medium.

### BACKGROUND

At present, the driving track of the vehicle is required to be restored in some scenes. The existing restoration method mainly depends on the positioning function of the vehicle, for example, the positioning data of the vehicle can be obtained, and the historical driving track of the vehicle can be restored by analyzing the positions of the vehicle at different time points.

### SUMMARY

The disclosure provides a track restoration method, a track restoration device and a non-transitory computer-readable storage medium.

According to a first aspect of the present disclosure, a track restoration method is provided, including:
acquiring vehicle-passing data in a target area, where the vehicle-passing data is generated based on shooting data, and the shooting data is obtained by shooting a vehicle in the target area by a shooting device in the target area;
restoring a driving track of the vehicle shot by the shooting device, based on the vehicle-passing data.

According to a second aspect of the present disclosure, a track restoration device is provided, including:
at least one processor; and
a memory communicatively coupled to the at least one processor; where
the memory stores a computer program executable by the at least one processor, and the computer program is executed by the least one processor to perform:
   acquiring vehicle-passing data in a target area, where the vehicle-passing data is generated based on shooting data, and the shooting data is obtained by shooting a vehicle in the target area by a shooting device in the target area;
   restoring a driving track of the vehicle shot by the shooting device, based on the vehicle-passing data.

According to a third aspect of the present disclosure, a non-transitory computer-readable storage medium is provided, where a computer program is stored in the non-transitory computer-readable storage medium, and the computer program is executed by a processor to perform:
acquiring vehicle-passing data in a target area, where the vehicle-passing data is generated based on shooting data, and the shooting data is obtained by shooting a vehicle in the target area by a shooting device in the target area;
restoring a driving track of the vehicle shot by the shooting device, based on the vehicle-passing data.

According to the present disclosure, the vehicle in the target area is shot by the shooting device in the target area to generate the vehicle-passing data in the target area, and then the driving track of the vehicle in the target area is restored based on the vehicle-passing data. In this way, since the restoration does not need to rely on the positioning function of the vehicle itself, the driving track of the vehicle can be restored even when the vehicle does not have the positioning function, thereby improving the restoring effect of the driving track of the vehicle.

### BRIEF DESCRIPTION OF THE DRAWINGS

The drawings are included to provide a better understanding of the present solution and are not to be construed as limiting the present disclosure. Wherein:

FIG. 1 is a flowchart of a track restoring method in an embodiment of the present disclosure;

FIG. 2 is a first schematic view of a portion of a road network in an embodiment of the present disclosure;

FIG. 3 is a second schematic view of a portion of a road network in an embodiment of the present disclosure;

FIG. 4 is a third schematic view of a portion of a road network in an embodiment of the present disclosure;

FIG. 5 is a fourth schematic view of a portion of a road network in an embodiment of the present disclosure;

FIG. 6 is a fifth schematic view of a portion of a road network in an embodiment of the present disclosure;

FIG. 7 is a sixth schematic view of a portion of a road network in an embodiment of the present disclosure;

FIG. 8 is a first schematic view of a track restoration device in an embodiment of the present disclosure;

FIG. 9 is a schematic view of a restoration module in an embodiment of the present disclosure;

FIG. 10 is a second schematic view of a track restoration device in an embodiment of the present disclosure; and

FIG. 11 is a block diagram of an electronic device for implementing a track restoration method in an embodiment of the present disclosure.

### DETAILED DESCRIPTION

Exemplary embodiments of the present disclosure are described below with reference to the accompanying drawings, in which various details of embodiments of the present disclosure are included to assist understanding, and which are to be considered as merely exemplary. Accordingly, those of ordinary skill in the art will recognize that various changes and modifications of the embodiments described herein can be made without departing from the scope and spirit of the disclosure. Also, descriptions of well-known functions and constructions are omitted in the following description for clarity and conciseness.

Referring to FIG. 1, a track restoration method provided in the embodiment of the present disclosure includes the following steps:
Step S101: acquiring vehicle-passing data in a target area, where the vehicle-passing data is generated based on shooting data, and the shooting data is obtained by shooting a vehicle in the target area by a shooting device in the target area;
Step S102: restoring a driving track of the vehicle shot by the shooting device, based on the vehicle-passing data.

The target area can be any area where the driving track of the vehicle needs to be restored. Accordingly, the track restoration method can be applied to various scenes requiring track restoration, for example, in a traffic light signal control scene, the traffic flow of each intersection needs to be accurately determined, however, due to the coverage rate of the shooting device, it is impossible for each traffic intersection to have the shooting device, and therefore, the driving track of the vehicle needs to be restored, and after the driving tracks of all vehicles in the target area are restored, the traffic flow of each intersection in the target area can be determined. In addition, the track restoration method can also be applied to scenes such as traffic jam condition analysis and specific vehicle track restoration.

The above-mentioned shooting device may be a shooting device disposed at a traffic intersection. Because the existing traffic intersection is usually provided with the snapshot device, the image shot by the snapshot device at the traffic intersection can be directly obtained, and then the image is identified to obtain the vehicle-passing data. Therefore, the vehicle-passing data of different traffic intersections can be analyzed to analyze when the target vehicle passes through which traffic intersections, and then the driving track of the vehicle can be restored according to the time sequence of the target vehicle passing through the traffic intersections. The target vehicle may be any vehicle traveling within the target area.

According to the present disclosure, the vehicle in the target area is shot by the shooting device in the target area to generate the vehicle-passing data in the target area, and then the driving track of the vehicle in the target area is restored based on the vehicle-passing data. In this way, since the restoration does not need to rely on the positioning function of the vehicle itself, the driving track of the vehicle can be restored even when the vehicle does not have the positioning function, thereby improving the restoring effect of the driving track of the vehicle.

Optionally, the vehicle-passing data includes at least two target sub-data, the at least two target sub-data are in a one-to one correspondence to at least two location points in a road network corresponding to the target area, the target sub-data is the vehicle-passing data generated when a target vehicle passes through the corresponding location point, and the restoring the driving track of the vehicle shot by the shooting device based on the vehicle-passing data includes:
determining a passing sequence of the target vehicle between the at least two location points, based on the at least two target sub-data;
determining a connecting path between adjacent location points in the at least two location points, based on the passing sequence, to obtain a target driving track of the target vehicle.

It can be understood that the shooting device is disposed at each of the at least two positions.

The one-to-one correspondence between the at least two target sub-data and the at least two location points in the road network corresponding to the target area may be: the target sub-data is shot data obtained by shooting the target vehicle by the shooting device at the corresponding location point, and the vehicle-passing data is generated.

Specifically, when the target vehicle passes through any location point of at least two location points, the shooting device at the location point shoots the target vehicle to obtain shooting data, then image recognition is carried out on the shooting data, and the recognition result is used as target sub-data corresponding to the location point.

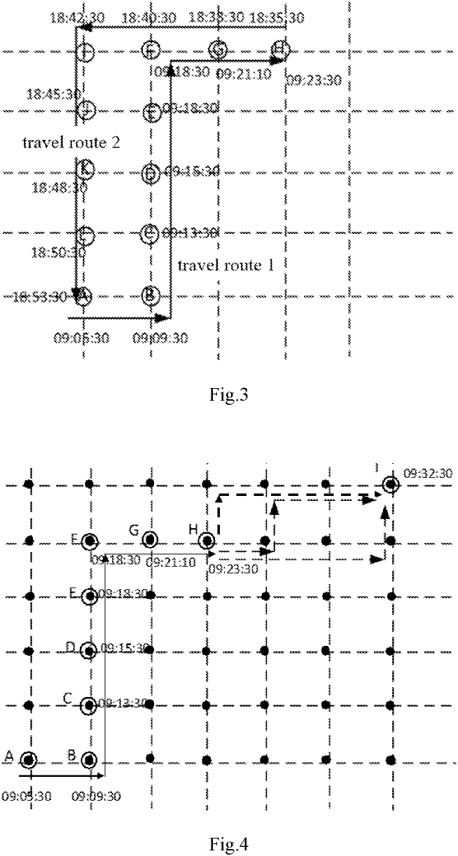

The target sub-data is vehicle-passing data generated based on the obtained shooting data shot by the shooting device, so that the passing sequence of the target vehicle between the at least two location points can be determined according to the shooting time of the shooting data corresponding to each target sub-data. For example, referring to FIG. 3, the sequence of travel on the travel route 1 is: a → B → C → D → E → F → G → H. The passing sequence of the travel route 2 is as follows: h → G → F → I → J → K → L → A.

The at least two target sub-data are vehicle-passing data of the target vehicle in the same continuous driving process. The shooting time recorded in different target sub-data can be judged to determine whether the data is the vehicle-passing data in the same continuous driving process. For example, when it is determined whether two target sub-data corresponding to two adjacent location points are target sub-data in the same continuous driving process, a time range required for the vehicle to pass between the two location points may be counted in advance, and then, a time difference between shooting times recorded in the two target sub-data may be calculated, and if the time difference is within the time range, the two target sub-data are determined to be target sub-data in the same continuous driving process. Correspondingly, if the time difference is outside the time range, the two target sub-data are determined not to be the target sub-data in the same continuous driving process.

In an embodiment of the present disclosure, the road network may be a topological road network, and the road network may include:

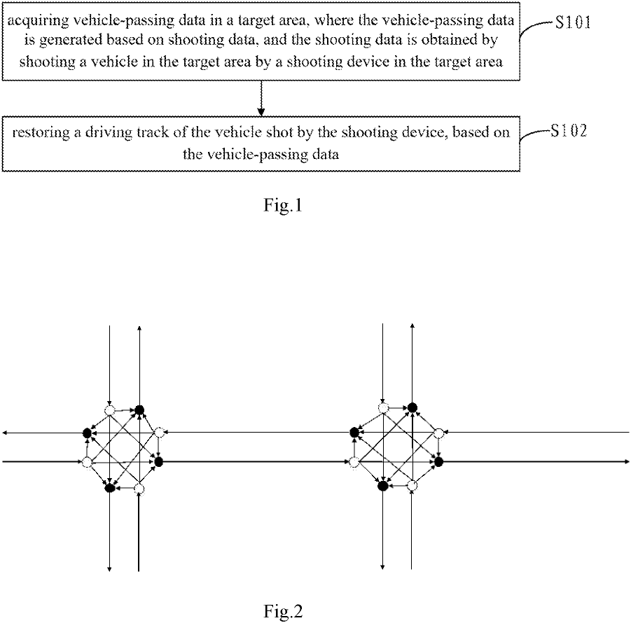

(1) vertex: the vertices of the topological road network are translated from branch objects (intersection branches, representing an entrance road or an exit road) in the map data, and one branch represents one vertex in the graph. According to the branch classification, the vertices are also classified into two categories, i.e., an entrance channel and an exit channel, and please refer to FIG. 2, the solid points in the intersection are the vertices of the entrance channel, and the hollow points in the intersection are the vertices of the entrance channel.

(2) edge: directed edges connecting different vertices are also classified into the following two types:

from exit lane vertex to entry lane vertex (type-1 edge): the type-1 edge is generally a link connecting adjacent intersections, i.e., a seg type in the map data, and referring to FIG. 2, the arrowed line graph located in the link is the type-1 edge.

From entrance lane vertex to exit lane vertex (type-2 edge): the type-2 edge is generally the flow direction inside a single intersection, corresponding to the flow class in the floor map data, please refer to FIG. 2, and the line graph with arrows in the intersection is the type-2 edge.

Specifically, the topological road network of the target area may be restored based on the map data of the target area. Specifically, all intersections, i.e., cross objects, in the map data may be extracted. Then, a branch at intersection (branch) object among the cross objects is extracted, and traffic direction (flow) information and section (seg) information associated with the branch object. The branch object is converted into a vertex in the road network, a type-1 edge is generated based on flow information, and a type-2 edge is generated based on seg information.

After generating the road network, the connectivity of the generated road network may be detected based on the following method:
under normal conditions, at least 1 connected path can be found between any two points in the road network;
isolated node (0 out-degree, 0 in-degree): isolated nodes cannot appear in the road network, and the intersection cannot be an intersection provided with a bayonet electric alarm, otherwise, the connectivity of the road network has problems;
0 in-degree node: can only occur at the border;
0 out-degree node: can only occur at the border;
when it is detected that the above defective node exists in the road network, the road network may be corrected, for example, the defective node may be deleted.

In this embodiment, a passing sequence of the target vehicle between the at least two location points is determined, and then a connection path is determined between two adjacent location points in the road network according to the passing sequence, so that a driving track of the target vehicle between any two adjacent location points is obtained, and a track recovery process of the target vehicle is realized.

Optionally, the target sub-data includes: identity information of the target vehicle, shooting time information and shooting location information of the shooting device for shooting the target vehicle.

The identity information may include vehicle attribute information such as a license plate number, a vehicle color, and a vehicle model of the target vehicle. Since the target sub-data is vehicle-passing data generated based on shot data, the shot time information may be shot time during shooting of the target vehicle by the shooting device to obtain the shot data. The above-mentioned shooting location information may be determined according to a device number of the shooting device. Specifically, since the position where the shooting device is arranged can be acquired in advance, and different shooting devices generally have different device codes, the photographed location information can be determined by acquiring the device codes of the shooting devices.

It can be understood that the vehicle-passing data in the target area may include a plurality of pieces of sub data, where each piece of sub data may be the vehicle-passing data generated based on one shooting of the shooting device. And the plurality of pieces of sub data can include the vehicle-passing data of the target vehicle and the vehicle-passing data of other vehicles except the target vehicle.

Based on this, before determining the passing order of the target vehicle between the at least two location points based on the at least two target sub data, the method may further include: and acquiring the identity information of the target vehicle, and screening the vehicle-passing data of the target area based on the identity information of the target vehicle to obtain the at least two pieces of target sub-data.

Then, the passing order of the target vehicles may be determined based on the shooting time information and the shooting place information in the target sub data.

In one embodiment of the present disclosure, any piece of passing data may include the following fields:

| Serial number | Field(s) | Types | Explanation |
|---|---|---|---|
| 1 | Device numbering | Character string | name or ID for uniquely identifying the shooting device, and the license plate data source can be a bayonet electric alarm, an RFID and the like |
| 2 | License plate number | Character string | license plate number of vehicle being snapshotted |
| 3 | Color of license plate | Character string | color of the license plate of the vehicle is snapshotted, the color is integrated as white, yellow, blue, black and green (gradual change green, etc.) |
| 4 | Time of taking a candid photograph | String/time data type | time data format of the vehicle-passing through the bayonet is “YYYYY-MM-DD HH MM SS” |
| 5 | Equipment snapshot lane number | Character string | illustrating which lane of the device the vehicle was snapshotted on; |

further, since the shooting device is a shooting device arranged in the road network, the association relationship between the shooting device and the road network may be constructed based on the following table:

| Serial number | Field(s) | Types | Explanation |
|---|---|---|---|
| 1 | Device number | Character string | name or ID for uniquely identifying the device, and the license plate data source can be a bayonet electric alarm, RFID, etc. |
| 2 | Equipment snapshot lane number | Character string | illustrating which lane of the device the vehicle was snapshotted on; |
| 3 | Intersection number | Character string | unique number of intersection where bayonet is located |
| 4 | entrance lane number | Character string | entrance lane of bayonet snapshot intersection |
| 5 | lane number | Character string | bayonet snapshot is carried out on which lane of the crossing entrance way; |

in this embodiment, the target sub-data includes: the identity information of the target vehicle, the shooting time information and the shooting location information of the shooting device for shooting the target vehicle can be used for determining the passing sequence of the target vehicle based on the target sub-data, and therefore the track restoration of the target vehicle can be achieved.

Optionally, the determining the connecting path between adjacent location points in the at least two location points based on the passing sequence includes:

in a case that there is one candidate path between a first location point and a second location point is 1, determining the candidate path as a connecting path between the first location point and the second location point, where the first location point and the second location point are any two adj acent location points of the at least two location points.

The number of candidate paths between the first location point and the second location point being 1 may be: the first location point and the second location point are two adjacent traffic intersections, and at this moment, a section between the two adjacent traffic intersections forms a unique candidate path between the first location point and the second location point, namely a driving track of the target vehicle between the first location point and the second location point. For example, referring to FIG. 5, in an embodiment of the present disclosure, the first location point is the intersection Cr-1 of the entrance lane Vr-1, and the second location point is the intersection Cr of the entrance lane Vr, in this case, the section between the intersection Cr-1 of the entrance lane Vr-1 and the intersection Cr of the entrance lane Vr may be directly determined as the connection link between the first location point and the second location point.

In this embodiment, in the case that a quantity of candidate paths between a first location point and a second location point is 1, the candidate path is directly determined as a connection path between the first location point and the second location point, thereby implementing a track restoration process under the condition of having only one candidate path.

Referring to FIG. 6, since the “intersection Cr-1 of the entrance lane Vr-1” and the “intersection Cr of the entrance lane Vr” are not adjacent traffic intersections, in this case, the connection path may be determined between the “intersection Cr-1 of the entrance lane Vr-1” and the “intersection Cr of the entrance lane Vr” based on a preset means.

Optionally, the determining the connecting path between adjacent location points in the at least two location points based on the passing sequence includes:
in a case where a quantity of candidate paths between the first location point and the second location point is greater than 1, determining the connection path between the first location point and the second location point as any one of:
   the candidate path with a shortest length in the candidate paths between the first location point and the second location point;
   the candidate path with a shortest passing time of the target vehicle in the candidate paths between the first location point and the second location point;
   the candidate path with fewest turns in the candidate paths between the first location point and the second location point; or
   the candidate path with a maximum historical passing times of the target vehicle in the candidate paths between the first location point and the second location point.

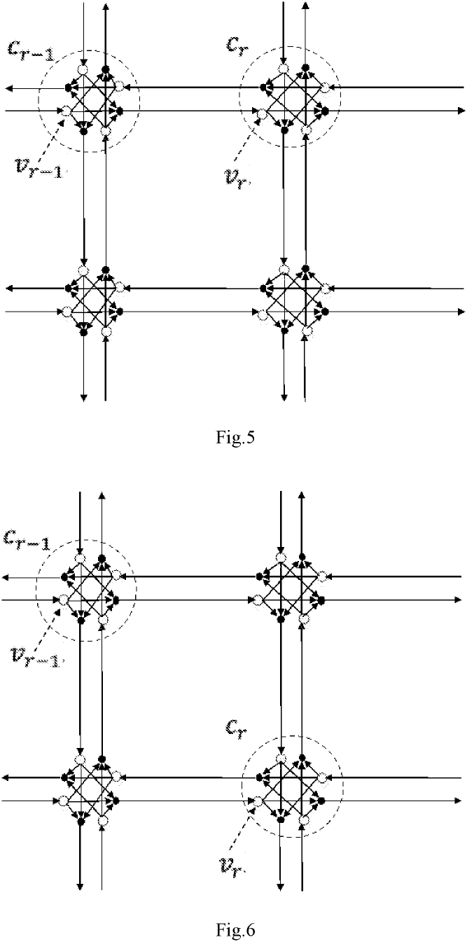

Referring to FIG. 4, in an embodiment of the present disclosure, the first location point is a point H, the second location point is a point I, and since the first location point and the second location point are not adjacent traffic intersections, there are multiple candidate paths for the target vehicle to travel from the first location point to the second location point. At this time, a target candidate path is selected from the multiple candidate paths as a connecting path between the first location point and the second location point, so as to achieve that the track of the target vehicle is restored.

In an embodiment of the present disclosure, the length of each candidate path may be determined separately, and then, among the candidate paths between the first location point and the second location point, a candidate path with the shortest length is determined as a connection path between the first location point and the second location point.

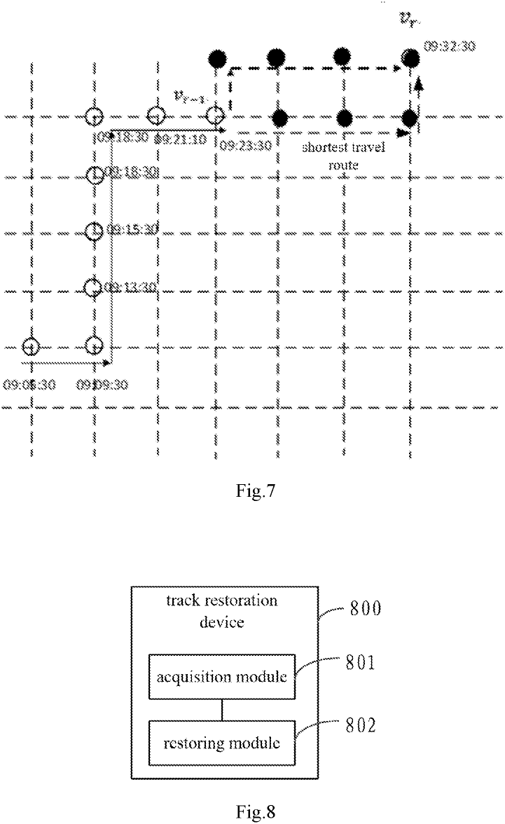

In another embodiment of the present disclosure, a passing time required for a target vehicle to pass through each candidate path may be determined, and then, of the candidate paths between the first location point and the second location point, a candidate path in which the target vehicle-passing time is shortest is determined as a connecting path between the first location point and the second location point. For example, referring to FIG. 7, the shortest trip path from Vr-1 to Vr may be determined as the connection path from Vr-1 to Vr.

In another embodiment of the present disclosure, the number of turns of each candidate path may be counted, and a candidate path with the smallest number of turns among the candidate paths between the first location point and the second location point is determined as a connection path between the first location point and the second location point.

In another embodiment of the present disclosure, historical traffic data of the target vehicle between the first location point and the second location point may also be obtained, and a candidate path with the largest number of historical traffics of the target vehicle among candidate paths between the first location point and the second location point is determined as a connecting path between the first location point and the second location point.

In the embodiment, when at least two candidate paths exist between the first location point and the second location point, the candidate paths which are more likely to be selected by the user are determined by comparing information such as the passing time, the length, the turning times and the passing preference of the user after different candidate paths, so that the accuracy of track restoration is further improved.

Optionally, a traffic intersection in the target area forms a connecting node in the road network, a segment in the target area connecting two adjacent traffic intersections forms a connecting edge in the road network, the candidate path includes at least one of the connecting edges, the method further including:
determining an average passing time of each connecting edge in the road network;
determining a passing time of the target vehicle to pass through the candidate path, based on the average passing time.

In this embodiment, the average passing time of each connecting edge in the road network is calculated, and the candidate path includes the knowledge-integrated connecting edge, so that when the passing time of a certain candidate path needs to be calculated, the passing time of the candidate path can be obtained only by summing up the average passing times of all the connecting edges included in the candidate path.

Optionally, the determining the average passing time of each connecting edge in the road network includes at least one of:
when road condition information of a target connecting edge is acquired, determining an average passing time of the target connecting edge based on the road condition information, where the target connecting edge is any connecting edge in the road network, and the road condition information includes an actual passing time of a vehicle to passes through the target connecting edge;
when road condition information of a target connecting edge is not acquired, determining an average passing time of the target connecting edge based on a road grade of the target connecting edge, where different road grades correspond to different average passing time.

In particular, since there are some service platforms in the related art that can acquire traffic data of a part of vehicles, for example, an existing positioning or navigation service platform can acquire traffic data of a vehicle using a service provided by the existing positioning or navigation service platform. In this way, the service platform can determine the time spent by the vehicle actually passing through the road section corresponding to the target connection edge through the traffic data, and can obtain the average traffic time of the target connection edge by counting the average traffic time of all vehicles passing through the road section corresponding to the target connection edge in a certain time period.

In addition, since the service platform may not necessarily acquire intersection information of all road segments in the target area, when the road condition information of the target connection edge is not acquired, the average passing time of the target connection edge may be determined based on the road grade of the road to which the target connection edge belongs.

Specifically, since the allowable travel speeds of the roads at different levels are generally different, the average passing time may be calculated from the length of the link and the allowable transit speed of the link.

Please see the following table for recommended design speeds for different road classes:

| | | | | | | | | |
|---|---|---|---|---|---|---|---|---|
| Road grade | 1-high high way | 2-loop and express way | 3-trunk road | 4-secondary road | 5-branch road | 101-province high way | 102-national road | 103-province road |
| Recommending design speed | 100 km/h | 80 km/h | 50 km/h | 40 km/h | 30 km/h | 100 km/h | 80 km/h | 60 km/h |

therefore, when the average passing time of the target connecting edge cannot be determined based on the road condition information, the corresponding recommended design speed can be determined according to the road grade of the target connecting edge, and then the average passing time of the target connecting edge can be obtained by dividing the length of the road section corresponding to the target connecting edge by the recommended design speed.

In an embodiment of the present disclosure, for the same target connection edge, the corresponding average passing time may also be determined according to different time periods, for example, please refer to the following table as an embodiment of the present disclosure:

| Time of day | Average passage time(s) | Time of day | Average passage time(s) | Time of day | Average passage time(s) |
|---|---|---|---|---|---|
| 202101-0400:00:00 | 150 | 202101-0408:00:00 | 168 | 202101-0416:00:00 | 163 |
| 202101-0401:00:00 | 149 | 202101-0409:00:00 | 170 | 202101-0417:00:00 | 170 |
| 202101-0402:00:00 | 145 | 202101-0410:00:00 | 171 | 202101-0418:00:00 | 171 |

in the embodiment, the average passing time of each connecting edge in the road network is determined, so that the passing time of the candidate path can be calculated according to the average passing time of the connecting edge, and the optimal candidate path can be conveniently determined, so that the track restoration effect is improved.

In another embodiment of the present disclosure, when it is required to track a specific vehicle, for the same target vehicle, at least two target driving track may be output at the same time, for example, the track of the target vehicle may be restored, all possible driving track of the target vehicle are obtained, and then at least two driving track with the shortest path length are selected from the driving track and are respectively determined as the target driving track.

Referring to FIG. 8, which is a schematic view of a track restoration device 800 in an embodiment of the present disclosure, the track restoration device 800 includes:
an acquisition module 801, configured to acquire vehicle-passing data in a target area, where the vehicle-passing data is generated based on shooting data, and the shooting data is obtained by shooting a vehicle in the target area by a shooting device in the target area;
a restoring module 802, configured to restore a driving track of the vehicle shot by the shooting device, based on the vehicle-passing data.

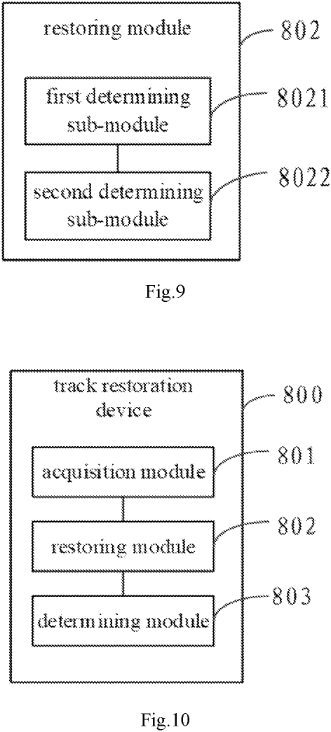

Optionally, the vehicle-passing data includes at least two target sub-data, the at least two target sub-data are in a one-to one correspondence to at least two location points in a road network corresponding to the target area, the target sub-data is the vehicle-passing data generated when a target vehicle passes through the corresponding location point. As shown in FIG. 9, the restoring module 802 includes:
a first determining sub-module 8021, configured to determine a passing sequence of the target vehicle between the at least two location points, based on the at least two target sub-data;
a second determining sub-module 8022, configured to determine a connecting path between adjacent location points in the at least two location points, based on the passing sequence, to obtain a target driving track of the target vehicle.

Optionally, the target sub-data includes: identity information of the target vehicle, shooting time information and shooting location information of the shooting device for shooting the target vehicle.

Optionally, the second determining sub-module 8022 is further configured to:

in a case that there is one candidate path between a first location point and a second location point is 1, determine the candidate path as a connecting path between the first location point and the second location point, where the first location point and the second location point are any two adjacent location points of the at least two location points.

Optionally, the second determining sub-module 8022 is further configured to:

in a case where a quantity of candidate paths between the first location point and the second location point is greater than 1, determine the connection path between the first location point and the second location point as any one of:
the candidate path with a shortest length in the candidate paths between the first location point and the second location point;
the candidate path with a shortest passing time of the target vehicle in the candidate paths between the first location point and the second location point;
the candidate path with fewest turns in the candidate paths between the first location point and the second location point; or
the candidate path with a maximum historical passing times of the target vehicle in the candidate paths between the first location point and the second location point.

Optionally, a traffic intersection in the target area forms a connecting node in the road network, a segment in the target area connecting two adjacent traffic intersections forms a connecting edge in the road network, the candidate path includes at least one of the connecting edges. As shown in FIG. 10, the device further includes:

a determining module 803, configured to determine an average passing time of each connecting edge in the road network.

The determining module 803 is further configured to determine a passing time of the target vehicle to pass through the candidate path, based on the average passing time.

Optionally, the determining module 803 is further configured to:

when road condition information of a target connecting edge is acquired, determine an average passing time of the target connecting edge based on the road condition information, where the target connecting edge is any connecting edge in the road network, and the road condition information includes an actual passing time of a vehicle to passes through the target connecting edge.

The determining module 803 is further configured to:

when road condition information of a target connecting edge is not acquired, determine an average passing time of the target connecting edge based on a road grade of the target connecting edge, where different road grades correspond to different average passing time.

It should be noted that the track restoring device 800 provided in this embodiment can implement all technical solutions of the track restoring method embodiments, so that at least all technical effects can be implemented, and details are not described here.

In the technical scheme of the disclosure, the acquisition, storage, application and the like of the personal information of the related user all accord with the regulations of related laws and regulations, and do not violate the customs of public sequences.

The present disclosure also provides an electronic device, a non-transitory computer-readable storage medium, and a computer program product according to embodiments of the present disclosure.

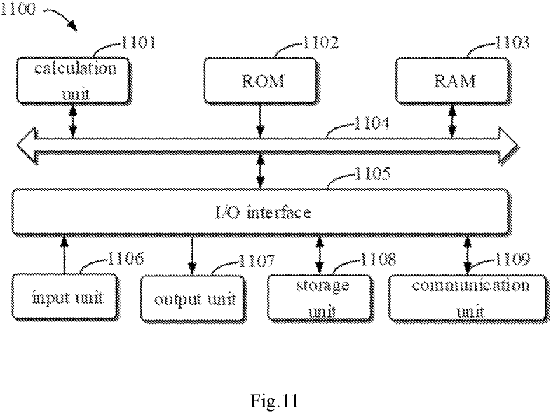

FIG. 11 shows a schematic block diagram of an example electronic device 1100 that may be used to implement embodiments of the present disclosure. Electronic devices are intended to represent various forms of digital computers, such as laptops, desktops, workstations, personal digital assistants, servers, blade servers, mainframes, and other appropriate computers. Electronic devices may also represent various forms of mobile devices, such as personal digital processors, cellular telephones, smart phones, wearable devices, and other similar computing devices. The components shown herein, their connections and relationships, and their functions, are meant to be examples only, and are not intended to limit implementations of the disclosure described and/or claimed herein.

As shown in FIG. 11, the electronic device 1100 includes a calculation unit 1101, which can perform various appropriate actions and processes according to a computer program stored in a Read Only Memory (ROM) 1102 or a computer program loaded from a storage unit 1108 into a Random Access Memory (RAM) 1103. In the RAM 1103, various programs and data necessary for the operation of the device 1100 may also be stored. The calculation unit 1101, the ROM 1102, and the RAM 1103 are connected to each other by a bus 1104. An input/output (I/O) interface 1105 is also connected to bus 1104.

A number of components in electronic device 1100 are connected to I/O interface 1105, including: an input unit 1106 such as a keyboard, mouse, or the like; an output unit 1107 such as various types of displays, speakers, and the like; a storage unit 1108, such as a magnetic disk, optical disk, or the like; and a communication unit 1109 such as a network card, a modem, a wireless communication transceiver, and the like. The communication unit 1109 allows the device 1100 to exchange information/data with other devices via a computer network such as the internet and/or various telecommunication networks.

The calculation unit 1101 can be a variety of general and/or special purpose processing components having processing and computing capabilities. Some examples of the calculation unit 1101 include, but are not limited to, a Central Processing Unit (CPU), a Graphics Processing Unit (GPU), various dedicated Artificial Intelligence (AI) computing chips, various calculation units running machine learning model algorithms, a Digital Signal Processor (DSP), and any suitable processor, controller, microcontroller, and so forth. The calculation unit 1101 performs the respective methods and processes described above, such as the track restoration method. For example, in some embodiments, the track restoration method may be implemented as a computer software program tangibly embodied on a machine-readable medium, such as storage unit 1108. In some embodiments, part or all of the computer program may be loaded and/or installed onto device 1100 via ROM 1102 and/or communications unit 1109. When the computer program is loaded into the RAM 1103 and executed by the calculation unit 1101, one or more steps of the track restoration method described above are performed. Alternatively, in other embodiments, the calculation unit 1101 may be configured to perform the track restoration method in any other suitable manner (e.g., by means of firmware).

Various implementations of the systems and techniques described here above may be implemented in digital electronic circuitry, integrated circuitry, Field Programmable Gate Arrays (FPGAs), Application Specific Integrated Circuits (ASICs), Application Specific Standard Products (ASSPs), system on a chip (SOCs), load programmable logic devices (CPLDs), computer hardware, firmware, software, and/or combinations thereof. These various embodiments may include: implemented in one or more computer programs that are executable and/or interpretable on a programmable system including at least one programmable processor, which may be special or general purpose, receiving data and instructions from, and transmitting data and instructions to, a storage system, at least one input device, and at least one output device.

Program code for implementing the methods of the present disclosure may be written in any combination of one or more programming languages. These program code may be provided to a processor or controller of a general purpose computer, special purpose computer, or other programmable data processing device, such that the program code, when executed by the processor or controller, causes the functions/acts specified in the flowchart and/or block diagram to be performed. The program code may execute entirely on the machine, partly on the machine, as a stand-alone software package, partly on the machine and partly on a remote machine or entirely on the remote machine or server.

In the context of this disclosure, a machine-readable medium may be a tangible medium that can contain, or store a program for use by or in connection with an instruction execution system, device, or device. The machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. More specific examples of a machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

To provide for interaction with a user, the systems and techniques described here can be implemented on a computer having: a display device (e.g., a CRT (cathode ray tube) or LCD (liquid crystal display) monitor) for displaying information to a user; and a keyboard and a pointing device (e.g., a mouse or a trackball) by which a user may provide input to the computer. Other kinds of devices may also be used to provide for interaction with a user; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a user computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include: local Area Networks (LANs), Wide Area Networks (WANs), and the Internet.

The computer system may include clients and servers. A client and server are generally remote from each other and typically interact through a communication network. The relationship of client and server arises by virtue of computer programs running on the respective computers and having a client-server relationship to each other. The server may be a cloud server, a server of a distributed system, or a server combining a blockchain.

It should be understood that various forms of the flows shown above, reordering, adding or deleting steps, may be used. For example, the steps described in the present disclosure may be executed in parallel, sequentially or in different orders, and are not limited herein as long as the desired results of the technical solutions disclosed in the present disclosure can be achieved.

The above detailed description should not be construed as limiting the scope of the disclosure. It should be understood by those skilled in the art that various modifications, combinations, sub-combinations and substitutions may be made, depending on design requirements and other factors. Any modification, equivalent replacement, and improvement made within principle of the present disclosure should be included in the scope of the present disclosure.

What is claimed is:

1. A track restoration method, comprising:
acquiring vehicle-passing data in a target area, wherein the vehicle-passing data is generated based on shooting data, and the shooting data is obtained by shooting a vehicle in the target area by a shooting device in the target area;
restoring a driving track of the vehicle shot by the shooting device, based on the vehicle-passing data.

2. The method according to claim 1, wherein the vehicle-passing data comprises at least two target sub-data, the at least two target sub-data are in a one-to one correspondence to at least two location points in a road network corresponding to the target area, the target sub-data is the vehicle-passing data generated when a target vehicle passes through the corresponding location point, and the restoring the driving track of the vehicle shot by the shooting device based on the vehicle-passing data comprises:
determining a passing sequence of the target vehicle between the at least two location points, based on the at least two target sub-data;
determining a connecting path between adjacent location points in the at least two location points, based on the passing sequence, to obtain a target driving track of the target vehicle.

3. The method according to claim 2, wherein the target sub-data comprises: identity information of the target vehicle, shooting time information and shooting location information of the shooting device for shooting the target vehicle.

4. The method according to claim 2, wherein the determining the connecting path between adjacent location points in the at least two location points based on the passing sequence comprises:
in a case that there is one candidate path between a first location point and a second location point is 1, determining the candidate path as a connecting path between the first location point and the second location point, wherein the first location point and the second location point are any two adjacent location points of the at least two location points.

5. The method according to claim 4, wherein the determining the connecting path between adjacent location points in the at least two location points based on the passing sequence comprises:
in a case where a quantity of candidate paths between the first location point and the second location point is greater than 1, determining the connection path between the first location point and the second location point as any one of:
the candidate path with a shortest length in the candidate paths between the first location point and the second location point;
the candidate path with a shortest passing time of the target vehicle in the candidate paths between the first location point and the second location point;
the candidate path with fewest turns in the candidate paths between the first location point and the second location point; or
the candidate path with a maximum historical passing times of the target vehicle in the candidate paths between the first location point and the second location point.

6. The method according to claim 5, wherein a traffic intersection in the target area forms a connecting node in the road network, a segment in the target area connecting two adjacent traffic intersections forms a connecting edge in the road network, the candidate path comprises at least one of the connecting edges, the method further comprising:
determining an average passing time of each connecting edge in the road network;
determining a passing time of the target vehicle to pass through the candidate path, based on the average passing time.

7. The method according to claim 6, wherein the determining the average passing time of each connecting edge in the road network comprises at least one of:
when road condition information of a target connecting edge is acquired, determining an average passing time of the target connecting edge based on the road condition information, wherein the target connecting edge is any connecting edge in the road network, and the road condition information comprises an actual passing time of a vehicle to passes through the target connecting edge;
when road condition information of a target connecting edge is not acquired, determining an average passing time of the target connecting edge based on a road grade of the target connecting edge, wherein different road grades correspond to different average passing time.

8. A track restoration device, comprising:
at least one processor; and
a memory communicatively coupled to the at least one processor; wherein
the memory stores a computer program executable by the at least one processor, and the computer program is executed by the least one processor to perform:
acquiring vehicle-passing data in a target area, wherein the vehicle-passing data is generated based on shooting data, and the shooting data is obtained by shooting a vehicle in the target area by a shooting device in the target area;
restoring a driving track of the vehicle shot by the shooting device, based on the vehicle-passing data.

9. The track restoration device according to claim 8, wherein the vehicle-passing data comprises at least two target sub-data, the at least two target sub-data are in a one-to one correspondence to at least two location points in a road network corresponding to the target area, the target sub-data is the vehicle-passing data generated when a target vehicle passes through the corresponding location point, and the computer program is executed by the least one processor to perform:
determining a passing sequence of the target vehicle between the at least two location points, based on the at least two target sub-data;
determining a connecting path between adjacent location points in the at least two location points, based on the passing sequence, to obtain a target driving track of the target vehicle.

10. The track restoration device according to claim 9, wherein the target sub-data comprises: identity information of the target vehicle, shooting time information and shooting location information of the shooting device for shooting the target vehicle.

11. The track restoration device according to claim 9, wherein the computer program is executed by the least one processor to perform:
in a case that there is one candidate path between a first location point and a second location point is 1, determining the candidate path as a connecting path between the first location point and the second location point, wherein the first location point and the second location point are any two adjacent location points of the at least two location points.

12. The track restoration device according to claim 11, wherein the computer program is executed by the least one processor to perform:
in a case where a quantity of candidate paths between the first location point and the second location point is greater than 1, determining the connection path between the first location point and the second location point as any one of:
the candidate path with a shortest length in the candidate paths between the first location point and the second location point;
the candidate path with a shortest passing time of the target vehicle in the candidate paths between the first location point and the second location point;
the candidate path with fewest turns in the candidate paths between the first location point and the second location point; or
the candidate path with a maximum historical passing times of the target vehicle in the candidate paths between the first location point and the second location point.

13. The track restoration device according to claim 12, wherein a traffic intersection in the target area forms a connecting node in the road network, a segment in the target area connecting two adjacent traffic intersections forms a connecting edge in the road network, the candidate path comprises at least one of the connecting edges, the computer program is executed by the least one processor to perform:
determining an average passing time of each connecting edge in the road network;
determining a passing time of the target vehicle to pass through the candidate path, based on the average passing time.

14. The track restoration device according to claim 13, wherein the computer program is executed by the least one processor to perform at least one of:
when road condition information of a target connecting edge is acquired, determining an average passing time of the target connecting edge based on the road condition information, wherein the target connecting edge is any connecting edge in the road network, and the road condition information comprises an actual passing time of a vehicle to passes through the target connecting edge;
when road condition information of a target connecting edge is not acquired, determining an average passing time of the target connecting edge based on a road grade of the target connecting edge, wherein different road grades correspond to different average passing time.

15. A non-transitory computer-readable storage medium, wherein a computer program is stored in the non-transitory computer-readable storage medium, and the computer program is executed by a processor to perform:
acquiring vehicle-passing data in a target area, wherein the vehicle-passing data is generated based on shooting data, and the shooting data is obtained by shooting a vehicle in the target area by a shooting device in the target area;
restoring a driving track of the vehicle shot by the shooting device, based on the vehicle-passing data.

16. The non-transitory computer-readable storage medium according to claim 15, wherein the vehicle-passing data comprises at least two target sub-data, the at least two target sub-data are in a one-to one correspondence to at least two location points in a road network corresponding to the target area, the target sub-data is the vehicle-passing data generated when a target vehicle passes through the corresponding location point, and the computer program is executed by the processor to perform:
determining a passing sequence of the target vehicle between the at least two location points, based on the at least two target sub-data;
determining a connecting path between adjacent location points in the at least two location points, based on the passing sequence, to obtain a target driving track of the target vehicle.

17. The non-transitory computer-readable storage medium according to claim 16, wherein the target sub-data comprises: identity information of the target vehicle, shooting time information and shooting location information of the shooting device for shooting the target vehicle.

18. The non-transitory computer-readable storage medium according to claim 16, wherein the computer program is executed by the processor to perform:
in a case that there is one candidate path between a first location point and a second location point is 1, determining the candidate path as a connecting path between the first location point and the second location point, wherein the first location point and the second location point are any two adjacent location points of the at least two location points.

19. The non-transitory computer-readable storage medium according to claim 18, wherein the computer program is executed by the processor to perform:
in a case where a quantity of candidate paths between the first location point and the second location point is greater than 1, determining the connection path between the first location point and the second location point as any one of:
the candidate path with a shortest length in the candidate paths between the first location point and the second location point;
the candidate path with a shortest passing time of the target vehicle in the candidate paths between the first location point and the second location point;
the candidate path with fewest turns in the candidate paths between the first location point and the second location point; or
the candidate path with a maximum historical passing times of the target vehicle in the candidate paths between the first location point and the second location point.

20. The non-transitory computer-readable storage medium according to claim 19, wherein a traffic intersection in the target area forms a connecting node in the road network, a segment in the target area connecting two adj acent traffic intersections forms a connecting edge in the road network, the candidate path comprises at least one of the connecting edges, the computer program is executed by the processor to perform:
determining an average passing time of each connecting edge in the road network;
determining a passing time of the target vehicle to pass through the candidate path, based on the average passing time.
